(19) United States
(12) Patent Application Publication
(10) Pub. No.: US 2013/0011314 A1
(43) Pub. Date: Jan. 10, 2013

(54) METHOD OF REMOVING ACID COMPOUNDS FROM A GASEOUS EFFLUENT WITH AN ABSORBENT SOLUTION BASED ON I, II/III DIAMINES

(76) Inventors: Fabien Porcheron, Mions (FR); Marc Jacquin, Lyon (FR); Bruno Delfort, Paris (FR); Dominique Le Pennec, Orgerus (FR); Julien Grandjean, Lyon (FR)

(21) Appl. No.: 13/515,334

(22) PCT Filed: Nov. 25, 2010
(86) PCT No.: PCT/FR10/00785

§ 371 Date: Sep. 24, 2012

(30) Foreign Application Priority Data
Dec. 16, 2009 (FR) 0906098

(51) Int. Cl. B01D 53/14; B01D 53/40

(52) U.S. Cl. 423/228; 423/210

(57) ABSTRACT

The invention relates to the removal of acid compounds from a gaseous effluent in an absorption method using an aqueous solution containing one or more diamines whose two amine functions are not connected to each other by rings and whose amine function in the α position is always tertiary and the amine function in the ω position is always either primary or secondary, more or less sterically hindered, and with have the general formula (I) as follows:

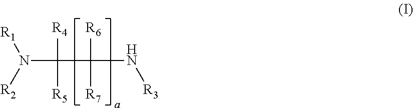

### CROSS-REFERENCE TO RELATED APPLICATIONS

Reference is made to French patent application Ser. No. 09/06.098, filed Dec. 16, 2009, and PCT Application FR 2010/00875, filed Nov. 25, 2010, which applications are incorporated herein by reference in their entity.

### BACKGROUND OF THE INVENTION

1. Field of the Invention

The present invention relates to the removal of acid compounds (H₂S, CO₂, COS, CS₂, mercaptans, etc.) from a gaseous effluent using an absorbent aqueous solution comprising diamines. The invention is advantageously applied to the treatment of gas of industrial origin and of natural gas.

2. Description of the Prior Art

Treatment of Gas of Industrial Origin

The nature of the gaseous effluents that can be treated is varied. Non-limitative examples thereof are syngas, combustion fumes, refinery gas, Claus tail gases, biomass fermentation gases, cement plant gases and blast furnace gases.

All of these gases contain acid compounds such as, for example, carbon dioxide (CO₂), hydrogen sulfide (H₂S), carbon oxysulfide (COS), carbon disulfide (CS₂) and mercaptans (RSH), mainly methylmercaptan (CH₃SH), ethylmercaptan (CH₃CH₂SH) and propylmercaptans (CH₃CH₂CH₂SH).

For example, in the case of combustion fumes, the gaseous effluent contains nitrogen, CO₂, oxygen and some sulfur-containing or nitrogen-containing impurities. CO₂ is the acid compound to be removed. In fact, carbon dioxide is one of the greenhouse gases widely produced by human activities and it has a direct impact on atmospheric pollution. In order to reduce the amounts of carbon dioxide discharged to the atmosphere, it is possible to capture the CO₂ contained in a gaseous effluent. By way of illustration, the goal of a post-combustion CO₂ capture unit is to reduce by 90% the CO₂ emissions of a thermal power plant. Decarbonation is generally carried out by washing the gas with an absorbent solution containing one or more amines.

Furthermore, in the case of syngas, the gaseous effluent contains carbon monoxide CO, hydrogen H₂, water vapour and carbon dioxide CO₂. It also comprises sulfur-containing impurities (H₂S, COS, etc.), nitrogen-containing impurities (NH₃, HCN) and halogenated impurities that have to be removed for the gas to eventually contain only residual proportions thereof. The impurities present in the non-purified syngas can cause accelerated corrosion of the plants and are likely to poison the catalysts used in chemical synthesis processes such as those used in the Fischer-Tropsch synthesis or methanol synthesis, or attenuate the performances of the materials used in fuel cells. Environmental considerations also require removing the impurities present in gases. In the particular case of Fischer-Tropsch synthesis, the specifications required at the inlet of the Fischer-Tropsch unit are particularly severe, and the proportions present in syngas must generally be less than 10 ppb weight for the sulfur-containing impurities. In order to reach such low sulfur-containing impurity contents, the gas is generally washed with an absorbent solution containing amines, combined with the use of capture masses.

Treatment of Natural Gas

The goal of deacidizing natural gas is to remove acid compounds such as carbon dioxide (CO₂), as well as hydrogen sulfide (H₂S), carbon oxysulfide (COS), carbon disulfide (CS₂) and mercaptans (RSH), mainly methylmercaptan (CH₃SH), ethylmercaptan (CH₃CH₂SH) and propylmercaptans (CH₃CH₂CH₂SH). The specifications generally used for deacidized gas are 2% CO₂, or even 50 ppm volume CO₂, the natural gas being thereafter subjected to liquefaction; 4 ppm H₂S and 10 to 50 ppm volume of total sulfur.

Deacidizing is therefore often carried out first, notably in order to remove the toxic acid gases such as H₂S in the first stage of the chain of processes and thus to avoid pollution of the various unit operations by these acid compounds, notably the dehydration section, the condensation and separation section intended for the heavier hydrocarbons. Deacidizing is generally carried out by washing the gas with an absorbent solution containing one or more amines.

Natural gases having all sorts of acid gas compositions can be found all over the world. Thus, there are gases containing mainly only H₂S or only CO₂, or these two gases in admixture. Besides, there are also natural gases very rich (up to vol. %) or very poor (around one hundred ppm) in acid compounds. In addition to the constraints due to the nature of the gas to be treated, the operator in charge of deacidizing this gas also has to take account of transport specification constraints (2% CO₂ for transport by pipeline and 50 ppm volume for transport by boat after liquefaction) and constraints related to the other units of the gas processing chain (for example a Claus type plant converting the toxic H₂S to inert sulfur does not tolerate more than 65% CO₂). In order to meet all these constraints, the operator may have to carry out total deacidizing (CO₂ and H₂S), selective H₂S deacidizing, or deacidizing followed by a stage of H₂S enrichment of the acid gas.

Acid Compounds Removal by Absorption

Deacidizing gaseous effluents is generally carried out by washing with an absorbent solution. The absorbent solution allows absorption of the acid compounds present in the gaseous effluent (notably CO₂, H₂S, mercaptans, COS, CS₂).

In general terms, for treating acid effluents comprising acid compounds such as, for example, H₂S, CO₂, mercaptans, COS, SO₂, CS₂, using amine-based compounds is interesting due to their ease of use in aqueous solution.

The solvents commonly used today are aqueous solutions of primary, secondary or tertiary alkanolamine, in combination with an optional physical solvent. French Patent 2,820,430, which discloses gaseous effluent deacidizing methods are mentioned by way of example. U.S. Pat. No. 6,852,144, which describes a method of removing acid compounds from hydrocarbons is also mentioned for example. The method uses a water-methyldiethanolamine or water-triethanolamine absorbent solution containing a high proportion of a compound belonging to the following group: piperazine and/or methylpiperazine and/or morpholine.

U.S. Pat. No. 4,240,923 recommends using amines known as sterically hindered for removing acid compounds from a gaseous effluent. These amines notably afford advantages in terms of absorption capacity and regeneration energy. The structures described are notably piperidine-derived nitrogen-containing heterocycles where the α position of the nitrogen atom is hindered notably by an alkyl or alcohol group notably.

For example, in the case of CO₂ capture, the absorbed CO₂ reacts with the alkanolamine present in solution according to a reversible known exothermic reaction and leads to the formation of hydrogen carbonates, carbonates and/or carbamates, for allowing removal of the CO₂ from the gas to be treated.

Similarly, for the removal of H₂S from the gas to be treated, the absorbed H₂S reacts instantaneously with the alkanolamine present in solution according to a known reversible exothermic reaction and leads to the formation of hydrogen sulfide.

It is well known to the person skilled in the art that tertiary amines or secondary amines with severe steric hindrance have slower CO₂ capture kinetics than less hindered primary or secondary amines. On the other hand, tertiary or secondary amines with severe steric hindrance have instantaneous H₂S capture kinetics, which allows selective H₂S removal based on distinct kinetic performances (U.S. Pat. No. 4,405,581).

One limitation of the solvents commonly used today in total deacidizing applications is too slow CO₂ or COS capture kinetics. In cases where the CO₂ (or possibly COS) content of the raw gas is above the desired specifications and this acid gas is therefore to be removed, it is necessary to dimension the absorption column according to the reaction kinetics between the amine and the CO₂ (or possibly the COS). The slower the reaction kinetics, the greater the column height, all things being equal, knowing that there are several orders of magnitude between the reaction kinetics for a tertiary or highly sterically hindered amine, and a primary or secondary amine. This limitation is particularly great in the case of natural gas decarbonation or syngas desulfurization, since the absorption column is under pressure, and it therefore represents the major part of the investments.

Another limitation of the solvents commonly used today in selective H₂S deacidizing applications is too fast CO₂ capture kinetics. In fact, in some natural gas deacidizing cases, selective H₂S removal is sought by limiting to the maximum CO₂ absorption. This constraint is particularly important for gases to be treated having a CO₂ content that is already less than or equal to the desired specification. A maximum H₂S absorption capacity is then sought with a maximum H₂S absorption selectivity towards CO₂. This selectivity allows recovering an acid gas at the regenerator outlet having the highest H₂S concentration possible, which limits the size of the sulfur chain units downstream from the treatment and guarantees better operation. In some cases, an H₂S enrichment unit is necessary for concentrating the acid gas in H₂S. The most selective amine will also be sought in this case. Tertiary amines such as methyldiethanolamine or hindered amines exhibiting slow reaction kinetics with CO₂ are commonly used, but they have limited selectivities at high H₂S feed ratios.

Whether seeking maximum CO₂ capture kinetics in a total deacidizing application or minimum CO₂ capture kinetics in a selective application, it is always desirable to use a solvent having the highest cyclic capacity possible. Indeed, the higher the cyclic capacity of the solvent, the more limited the solvent flow rates required for deacidizing the gas to be treated.

One essential aspect of treating industrial fumes or gas with solvents is the absorption stage. Dimensioning of the absorption column is essential to provide proper operation of the unit. If, as mentioned above, the CO₂ capture kinetics are a determinant criterion for the column height, the cyclic capacity of the solvent is a determinant criterion for the column diameter. In fact, the higher the cyclic capacity of the solvent, the lower the solvent flow rate required for treating the acid gas. Thus, the lower the solvent flow rate circulating in the column, the smaller the absorption column diameter, without any column obstruction phenomenon. In an application where the absorption column is under pressure, such as natural gas or syngas treatment, the diameter of the column has a huge impact on the steel mass making up the absorption column, and therefore on its cost.

In the case of deacidizing at atmospheric pressure, the cost related to the construction of the absorption column is lower, but it can generally not be disregarded. If we take the example of post-combustion CO₂ capture is considered where the CO₂ concentration is very low, it is observed that the flow rate of gas to be treated is often a more dimensioning criterion than the solvent capacity. However, the solvent capacity and therefore the flow to be circulated in the plant will have a great impact on various investment and operating costs of the plant. The costs related to the pumps and the electric power required for operating them can be mentioned by way of example.

Another essential aspect of the operations for treating industrial gas or fumes with a solvent is the regeneration of the separation agent. Regeneration through expansion and/or distillation and/or entrainment by a vaporized gas referred to as “stripping gas” is generally provided depending on the absorption type (physical and/or chemical).

One of the limitations of the solvents commonly used today is the energy consumption necessary for solvent regeneration that is too high. This is particularly true in cases where the acid gas partial pressure is low. For example, for a 30 wt. % monoethanolamine aqueous solution used for post-combustion CO₂ capture in a thermal power plant fume, where the CO₂ partial pressure is of the order of 0.12 bar, the regeneration energy represents approximately 3.7 GJ per ton of CO₂ captured. Such an energy consumption represents a considerable operating cost for the CO₂ capture process.

It is well known that the energy required for regeneration by distillation of a chemical solvent can be divided into three different items: the energy required for heating the solvent between the top and the bottom of the regenerator, the energy required for lowering the acid gas partial pressure in the regenerator by vaporization of a stripping gas, and the energy required for breaking the chemical bond between the amine and the CO₂.

These first two items are inversely proportional to the absorbent solution flows to be circulated in the plant to achieve a given specification. In order to decrease the energy consumption linked with the regeneration of the solvent, it is therefore again preferable to maximize the cyclic capacity of the solvent.

The last item relates to the energy to be supplied for breaking the bond created between the amine used and the CO₂. In order to decrease the energy consumption linked with the regeneration of the solvent, it is thus preferable to minimize the bond enthalpy ΔH. However, it is not obvious to find a solvent having both a high cyclic capacity and a low reaction enthalpy. The best solvent regarding energy is therefore a solvent allowing to have the best compromise between a high cyclic capacity Δα and a low bond enthalpy ΔH.

It is difficult to find compounds or a family of compounds allowing the various deacidizing processes to operate at low operating costs (including the regeneration energy and the solvent circulation costs) and investments (including the height and the diameter of the absorption column), whether in a total deacidizing application or in a selective H₂S removal application.

The applicant has found that the compounds meeting the definition of the diamines below are of great interest in all the gaseous effluent treatment processes intended for acid compounds removal.

### SUMMARY OF THE INVENTION

The present invention overcomes one or more of the drawbacks of the prior art by providing a method for removing acid compounds such as CO₂, H₂S, COS, CS₂, SO₂ and mercaptans from a gas using a specific amine whose absorbent properties are greater than those of the reference amines used in post-combustion CO₂ capture applications and natural gas treatment applications, that is monoethanolamine (MEA) and methyldiethanolamine (MDEA) respectively.

The present invention describes a method of removing the acid compounds contained in a gaseous effluent, wherein an acid compound absorption stage is carried out by contacting the effluent with an absorbent solution comprising:

a—water,

b—between 21 and 80 wt. % of a diamine comprising a tertiary amine function and a primary or secondary amine function, the diamine having the general formula (I) as follows:

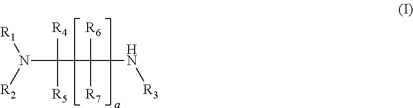

wherein:
a is an integer ranging between 1 and 11,
each radical R1 and R2 is selected independently from an alkyl C1-C12 group or from an alkoxyalkyl C1-C12 group,
each radical R3, R4, R5, R6 and R7 is selected from a hydrogen atom, an alkyl C1-C12 group and an alkoxyalkyl C1-C12 group; and
radical R3 is different from R1 and R2.

According to the invention, R1 and R2 can be connected to each other so as to form a heterocycle of piperidine, pyrrolidine, homopiperidine or morpholine type, the ring consisting of 5 to 8 atoms.

Preferably, radical R3 can be selected from an alkyl C1-C12 group and an alkoxyalkyl C1-C12 group.

The diamine can be selected from the group consisting of (N-morpholinoethyl) isopropylamine, (N-piperidinoethyl) isopropylamine, [N,N-dimethyl-N′-(3-methoxypropyl)]-1,2-propanediamine, [N,N-dimethyl-N′-(methane-2-tetrahydro-furfuryl)]-1,2-propanediamine, [N,N-dimethyl-N′-(2-butyl)]-1,3-propanediamine, [N,N-dimethyl-N′-(2-butyl)]-1,3-propanediamine, [N,N-dimethyl-N′-butyl]-1,3-propanediamine, [N,N-dimethyl-N′-(methyl-2-propyl)]-1,3-propanediamine, [N,N-dimethyl]-1,6-hexane-diamine, [N,N-diethyl]-1,6-hexanediamine and N,-diethyl-1,4-pentanediamine.

The primary or secondary amine function can be connected to at least one quaternary carbon or two tertiary carbons. In this case, the diamine can be selected from the group consisting of (N-morpholinoethyl) tertiobutylamine, [N,N-dimethyl-N′-isopropyl]-1,2-propanediamine, [N,N-dimethyl-N′-tertiobutyl]-1,2-propanediamine, [N,N-dimethyl-N′-tertiooctyl]-1,2-propanediamine, [N,N-dimethyl-N′-(2-butyl)]-1,2-propane-diamine and [N,N-dimethyl-N′-terbutyl]-1,3-propanediamine.

The absorbent solution can comprise between 10 and 60 wt. % diamine and between 10 and 90 wt. % water. The absorbent solution can also comprise a non-zero proportion, below 20 wt. %, of an activating compound, said compound comprising a primary or secondary amine function. The activating compound can be selected from the group consisting of:
MonoEthanolAmine,
N-butylethanolamine
Aminoethylethanolamine,
Diglycolamine,
piperazine,
N-(2-hydroxyethyl)piperazine,
N-(2-aminoethyl)piperazine,
Morpholine,
3-(methylamino)propylamine.

The absorbent solution can also comprise a physical solvent selected from among methanol and sulfolane.

The acid compound absorption stage can be carried out at a pressure ranging between 1 bar and 120 bars, and at a temperature ranging between 20° C. and 100° C.

In the method according to the invention, a stage of regeneration of the absorbent solution laden with acid compounds, wherein at least one of the following operations is performed: heating, expansion, distillation, can be carried out. The regeneration stage can be carried out at a pressure ranging between 1 bar and 10 bars, and at a temperature ranging between 100° C. and 180° C.

The gaseous effluent can be selected from among natural gas, syngas, combustion fumes, refinery gas, Claus tail gases, biomass fermentation gases, cement plant gases and incinerator fumes.

The method according to the invention can be implemented for selective H₂S removal from a gaseous effluent containing H₂S and CO₂.

In fact, the applicant has discovered that the compounds meeting the definition of the diamines according to the invention allow obtaining higher cyclic capacities than the reference amines, whether in applications where the acid gas partial pressure is low (for example for capture of the CO₂ contained in combustion fumes) or in applications where the acid gas partial pressure is high (for example natural gas treatment). This performance is certainly increased by the greater density of amine sites in relation to the molar mass of the molecules, and also by the fact that there is, on the same molecule, a primary or secondary amine function and a tertiary function that cannot form carbamates. By varying the steric hindrance of the primary or secondary amine function, it is possible to obtain high-performance amines in total deacidizing applications as well as in applications where selective H₂S removal is sought.

### BRIEF DESCRIPTION OF THE DRAWING

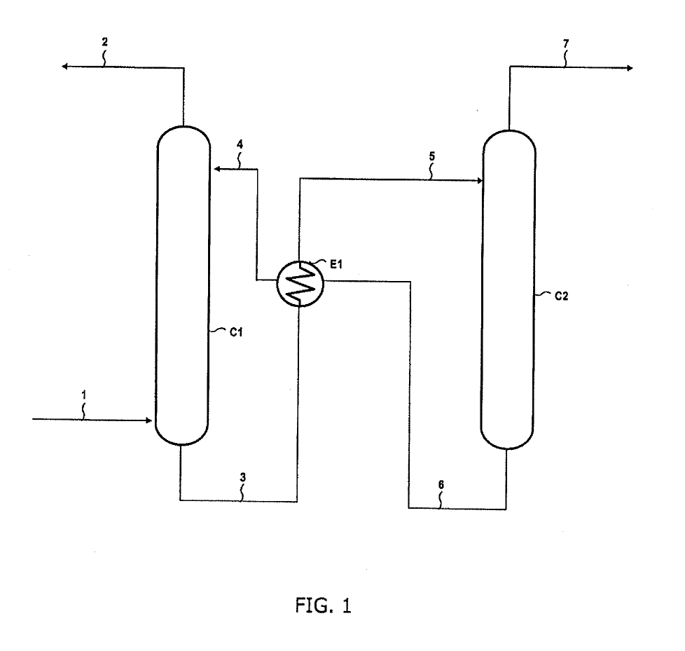

Other features and advantages of the invention will be clear from reading the description hereafter, with reference to FIG. 1 that shows a flow sheet of an acid gas effluent treating method.

### DETAILED DESCRIPTION OF THE INVENTION

The invention relates to a method of absorbing the acid compounds of a gaseous effluent by contacting the gaseous effluent with a liquid absorbent solution comprising:
water,
at least one diamine wherein the 2 amine functions are not connected to each other by rings and whose amine function in the α position is always tertiary and the amine function in the ω position is always either primary or secondary, wherein this function is more or less sterically hindered depending on the application, the diamine having the general formula (I) as follows and conditioned by the rules detailed hereafter:

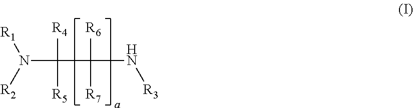

with:
a=1 to 11, preferably a=1 to 5 and more preferably a=1, 2 or 5;
R1 and R2 are selected from an alkyl C1 to C12, preferably C1 to C6 group and/or an alkoxyalkyl C1 to C12, preferably C1 to C6 group, linear, branched or cyclic. Preferably, R1 and R2 are independently selected from a methyl group and an ethyl group;
according to an embodiment, R1 and R2 are independent, that is they are not connected to each other. Alternatively, according to another embodiment, R1 and R2 can be connected to each other to form a heterocycle for example of piperidine, pyrrolidine, homopiperidine or morpholine type, the ring consisting of 5 to 8 atoms, preferably a ring with 5 to 6 atoms;
R3 is selected from among:
   a hydrogen atom, or
   a C1 to C12, preferably C1 to C6 alkyl or alkoxyalkyl group, linear, branched or cyclic
radical R3 is different from R1 and R2
R4, R5, R6 and R7 are indiscriminately selected from among hydrogen atoms or C1 to C12 alkyl or alkoxyalkyl groups, linear, branched or cyclic. Preferably, R4 and R5 are hydrogen atoms. Preferably, R6 and R7 are independently selected from among a hydrogen atom and a methyl group.

Preferably, R3 is selected from a C1 to C12, preferably C1 to C6 alkyl or alkoxyalkyl group, linear, branched or cyclic.

In the present description, an alkoxyalkyl group is understood to be a hydrocarbon group containing one or more oxygen atoms with at least one of which in form of an ether function.

Preferably, the absorbent solution used in the method according to the invention comprises no TMHDA.

Preferably, the absorbent solution used in the method according to the invention comprises a diamine according to the invention of formula (I) as described above, except for the alkyl derivatives of 1,6-hexanediamine. In the present description, the alkyl derivatives of 1,6-hexanediamine designate the compounds of formula (I) wherein each radical R1 and R2 is selected independently from an alkyl group containing 1 to 4 carbon atoms and wherein radical R3 is selected from a hydrogen atom or an alkyl group containing 1 to 4 carbon atoms.

Preferably, the absorbent solution used in the method according to the invention comprises a diamine according to the invention of formula (I) as described above, except for the following compounds: N,N-dimethylhexane-1,6-diamine and N,N,N′-trimethylhexane-1,6-diamine.

In particular, the invention relates to a method for selective H₂S removal from a gas containing H₂S and CO₂. For this application, the diamine according to the invention is so selected that the primary or secondary amine function is severely hindered, that is the primary or secondary amine function is connected to at least one quaternary carbon or to two tertiary carbons. In other words, the severely hindered primary or secondary amine function is connected to a quaternary carbon, a quaternary carbon and a tertiary carbon, two tertiary carbons or two quaternary carbons. Preferably, the severely hindered diamine according to the invention comprises a secondary amine function.

Examples of severely hindered compounds of general formula (I) can be given:
in cases where the diamine according to the invention has a quaternary carbon at alpha of the —NH— function, for example the compound of general formula (I) is such that groups R6 and R7 are hydrogens and group R3 is a tertiobutyl group;
in cases where the molecule has two tertiary carbons at alpha and at α′ of the —NH— function, for example the compound of general formula (I) is such that group R6 is a methyl group, group R7 is a hydrogen and group R3 is an isopropyl group; and
in cases where the carbon atom adjoining the nitrogen atom of a primary amine is quaternary, for example the compound of general formula (I) is such that R3 is a hydrogen atom, and R6 and R7 are each a methyl radical.

The compounds of general formulas (I) are of interest in all the acid gas (natural gas, combustion fumes, syngas, etc.) treatment processes in an absorbent solution aqueous composition.

The present invention removes acid compounds from a gaseous effluent using an absorbent compound in aqueous solution. The diamines according to the invention have a higher absorption capacity with acid compounds (notably CO₂, H₂S, COS, SO₂, CS₂, mercaptans) than the conventionally used monoethanolamine (MEA) and methyldiethanolamine (MDEA). Indeed, the diamines according to the invention have the specific feature of having very high feed ratios α=n_{acid gas}/nₐₘᵢₙₑ (α designating the ratio between the number of moles of acid compounds n_{acid gas} absorbed by a portion of absorbent solution and the number of moles of amine nₐₘᵢₙₑ contained in the absorbent solution portion) whatever the application that is sought, in comparison to the conventionally used MEA and MDEA. Using an aqueous absorbent solution according to the invention saves on the investment costs and the operating costs of a deacidizing plant (gas treatment and CO₂ capture). In the particular case of the diamines according to the invention for which the secondary amine function is severely hindered, the invention allows reduction of the amount of CO₂ captured for a higher H₂S feed ratio in comparison with MDEA. This capacity and selectivity gain leads to savings on the investment costs and the operating costs of the deacidizing plant and of the downstream Claus plant that treats a H₂S-richer gas.

Nature of the Gaseous Effluents

The absorbent solutions according to the invention can be used to deacidize the following gaseous effluents: natural gas, syngas, combustion fumes, refinery gas, Claus tail gas, biomass fermentation gas, cement plant gas and incinerator fumes. These gaseous effluents contain one or more of the following acid compounds: CO₂, H₂S, mercaptans, COS, CS₂, SO₂.

Combustion fumes are produced notably by the combustion of hydrocarbons, biogas, coal in a boiler or for a combustion gas turbine, for example in order to produce electricity. These fumes are at a temperature ranging between 20° C. and 60° C., at a pressure ranging between 1 and 5 bars, and they can comprise between 50 and 80% nitrogen, between 5 and 40% carbon dioxide, between 1 and 20% oxygen, and some impurities such as SOx and NOx if they have not been removed downstream of the deacidizing process.

Syngas contains carbon monoxide CO, hydrogen H₂ (generally with a H₂/CO ratio of 2), water vapour (generally at saturation at the wash temperature) and carbon dioxide CO₂ (of the order of 10%). The pressure generally ranges between and 30 bars, but it can reach up to 70 bars. It also comprises sulfur-containing (H₂S, COS, etc.), nitrogen-containing (NH₃, HCN) and halogenated impurities.

Natural gas predominantly consists of gaseous hydrocarbons, but it can contain some of the following acid compounds: CO₂, H₂S, mercaptans, COS, CS₂. The proportion of these acid compounds is very variable and it can reach up to 40% for CO₂ and H₂S. The temperature of the natural gas can range between 20° C. and 100° C. The pressure of the natural gas to be treated can range between 10 and 120 bars.

Examples of Synthesis Paths for Compounds of General Formula (I)

The diamines according to the invention can be synthesized according to various reaction paths. The following paths can be mentioned by way of non-exhaustive example:

A/ Condensation reactions for example

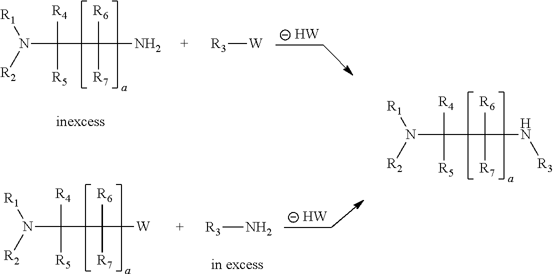

wherein W is a releasable group in the sense of organic chemistry. It is generally selected from a halogen atom, notably a chlorine, bromine or iodine atom. W can also be a tosylate or mesylate radical, well known as releasable groups. In some cases, the nitro groups can satisfy the reaction.

These are conventional condensation reactions. Obtaining the secondary amine function is conditioned by the excess primary amine, that is the ratio of the number of moles of primary amine to the number of moles of the synthon carrying the releasable group W. The ideal ratio for selectively obtaining a secondary amine and avoiding a second condensation reaction that would lead to a tertiary amine function has to be determined specifically for each reaction. Generally, this ratio ranges between 2 and 10, most often between 3 and 7.

It should be noted that one of the precursors of these reactions always carries a tertiary amine function. In some cases, these functions can be present in form of halohydrates, chlorhydrates for example.

B/ For example the following paths that can lead to diamines according to the invention. It is the addition of a primary amine to the unsaturation of an acrylamide derivative or the unsaturation of acrylonitrile, followed by the hydrogenation of the carbonyl function that converts the amide function to amine or the hydrogenation of the nitrile function that converts it to a primary amine function.

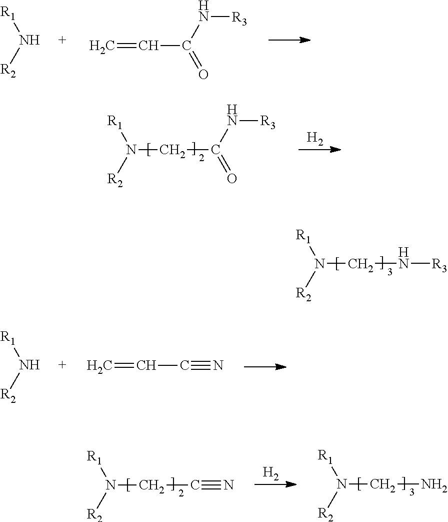

C/ For example the condensation reaction of a synthon carrying a primary amine with a synthon carrying a ketone or aldehyde carbonyl function, which leads to an imine, then, after hydrogenation, to a secondary amine. It can be illustrated as follows:

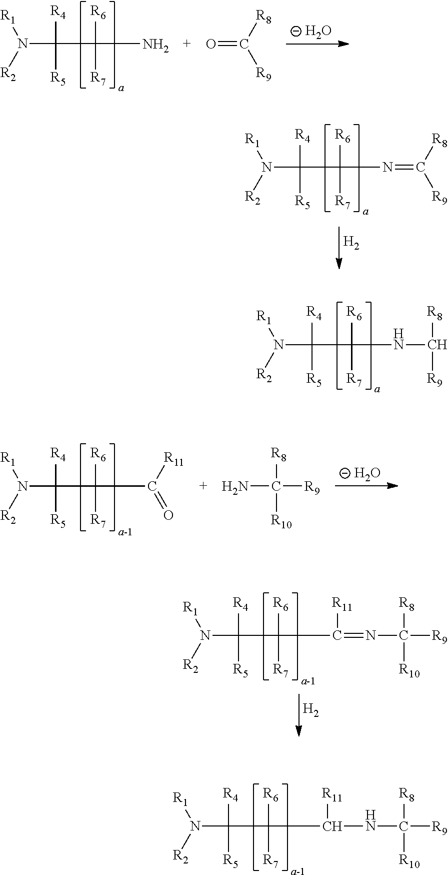

with here radicals —CHR8R9 and —CR8R9R10 compatible with the definition of R3 in general formula (I) and a radical R11 compatible with the definition of R6 or R7 in general formula (I).

D/ For example, diamines according to the invention can be obtained through partial alkylation of a primary or secondary diamine using known means for carrying out this type of reaction, such as the reaction of a primary or secondary amine with an aldehyde or a ketone in the presence of hydrogen and through the agency of a catalyst.

The diagram hereafter illustrates this synthesis path represented by way of example from a diamine having two primary amine functions, formaldehyde and hydrogen. Here, 8 products of different alkylation degrees can be obtained. 2 correspond to a diamine according to the invention.

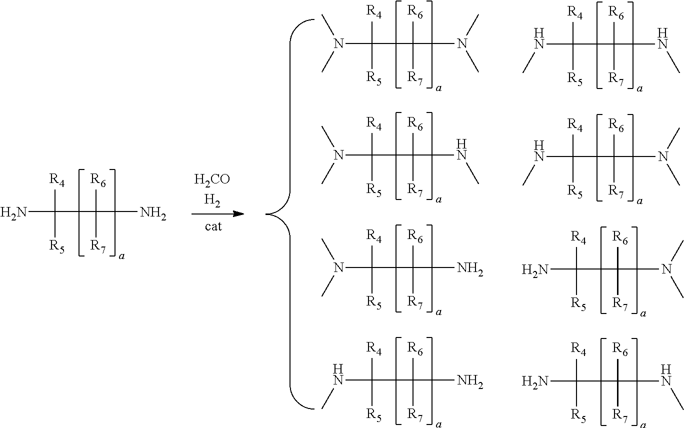

The diagram below illustrates this synthesis path represented by way of example from a diamine one function of which is tertiary and the other primary, formaldehyde and hydrogen. Here, 2 products of different alkylation degrees can be obtained. One of them corresponds to a diamine according to the invention.

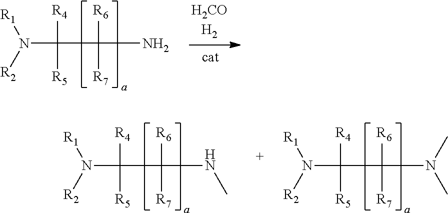

Examples of Diamines of General Formula (I)

Among the molecules of the invention, the following non-exhaustive list of molecules can be mentioned. The molecules of list a) having a low or moderate hindrance of the —NH— function have to be distinguished from the molecules of list b) having a severe hindrance of the —NH— function. The molecules of list b) are particularly suitable for selective H₂S removal from a gas containing H₂S and CO₂.

a) Molecules with low or moderate hindrance

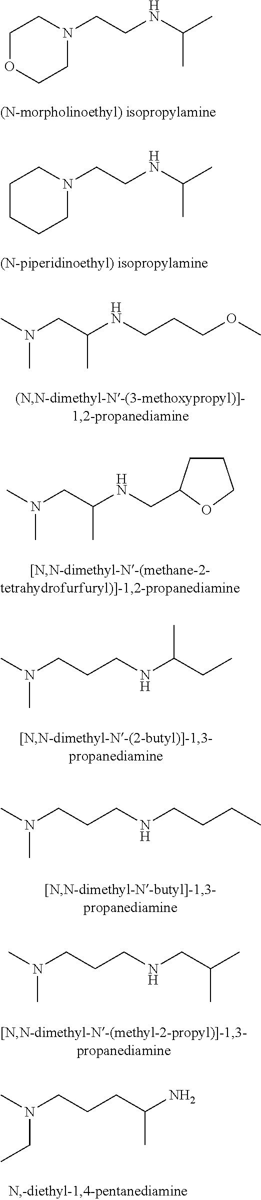

and possibly

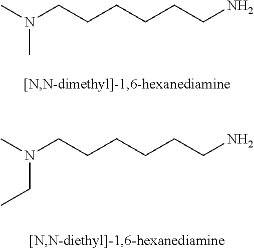

b) Molecules with severe hindrance

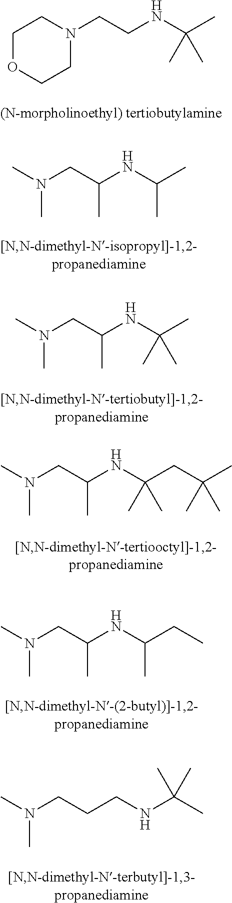

Composition of the Absorbent Aqueous Solution

The diamines according to the invention can be in variable concentrations, ranging for example between 21 and 80 wt. %, preferably between 25 and 60 wt. %, more preferably between 30 and 50 wt. % in the aqueous solution.

The absorbent solution can contain between 10 and 90 wt. % water, preferably between 50 and 70 wt. % water.

In an embodiment, the compounds of general formula (I) can be formulated with another amine containing at least one primary or secondary amine function (activator), up to a concentration of 20 wt. %, preferably below 15 wt. % and more preferably below 10 wt. %. This type of formulation is particularly interesting in the case of CO₂ capture in industrial fumes, or treatment of natural gas containing CO₂ and/or COS above the desired specification. Indeed, for this type of applications, one wants to increase the CO₂ and/or COS capture kinetics in order to reduce the size of the equipments.

A non-exhaustive list of compounds that can be used as activators is given below:
MonoEthanolAmine,
N-butylethanolamine
Aminoethylethanolamine,
Diglycolamine,
piperazine,
N-(2-hydroxyethyl)piperazine,
N-(2-aminoethyl)piperazine,
Morpholine,
3-(methylamino)propylamine.

The absorbent solution can contain a physical solvent, methanol or sulfolane for example.

In an embodiment, the compounds of general formula (I) can be formulated with another amine having a slow CO₂ capture kinetics, such as a tertiary amine for example. In this embodiment, it is the compound of general formula (I) that acts as the activator.

Method of Removing Acid Compounds from a Gaseous Effluent

Using an absorbent solution for deacidizing a gaseous effluent is achieved schematically by carrying out an absorption stage, followed by a regeneration stage, as shown in FIG. 1 for example. The absorption stage contacts the gaseous effluent containing the acid compounds to be removed with the absorbent solution in an absorption column C1. The gaseous effluent to be treated 1 and the absorbent solution 4 are fed into column C1. Upon contacting, the organic compounds provided with an amine function of absorbent solution 4 react with the acid compounds contained in effluent 1 so as to obtain a gaseous effluent depleted in acid compounds 2 that leaves the top of column C1 and an absorbent solution enriched in acid compounds 3 that leaves the bottom of column C1. The absorbent solution enriched in acid compounds 3 is sent to an exchanger E1 where it is heated by stream 6 coming from regeneration column C2. The laden absorbent solution 5 heated at the outlet of exchanger E1 is fed into distillation column (or regeneration column) C2 where regeneration of the absorbent solution laden with acid compounds takes place. Optionally, prior to being fed into column C2, absorbent solution 3 or 5 laden with acid compounds can be expanded. The regeneration stage can thus heat, optionally in expanding or in distilling the absorbent solution enriched in acid compounds in order to release the acid compounds that leave the top of column C2 in gas form 7. The regenerated absorbent solution, i.e. depleted in acid compounds 6, leaves the bottom of column C2 and flows into exchanger E1 where it yields heat to stream 3 as described above. The regenerated and cooled absorbent solution 4 is then recycled to absorption column C1.

The acid compound absorption stage can be carried out at a pressure ranging between 1 and 120 bars, preferably between 20 and 100 bars for natural gas treatment, preferably between 1 and 3 bars for industrial fumes treatment, and at a temperature ranging between 20° C. and 100° C., preferably between 30° C. and 90° C., or even between 30° C. and 60° C.

The regeneration stage of the method according to the invention can be carried out by thermal regeneration, optionally complemented by one or more expansion stages.

Regeneration can be carried out at a pressure ranging between 1 and 5 bars, or even up to 10 bars, and at a temperature ranging between 100° C. and 180° C., preferably between 130° C. and 170° C. Preferably, the regeneration temperature ranges between 155° C. and 180° C. in cases where one wants to reinject the acid gases. The regeneration temperature preferably ranges between 115° C. and 130° C. in cases where the acid gas is sent to the atmosphere or to a downstream treating process such as a Claus process or a tail gas treating process.

### EXAMPLES

The synthesis operating procedure is given for some molecules belonging to the family of compounds (I).

The absorbent solutions used in these examples are aqueous solutions comprising 30 wt. % diamine according to the invention.

The performances (i.e. CO₂ capture capacity) are compared, notably with those of a 30 wt. % MonoEthanolAmine aqueous solution that constitutes the reference absorbent solution for a post-combustion fumes capture application and those of a 40 wt. % MethylDiethanolAmine aqueous solution that constitutes the reference absorbent solution for a natural gas treatment application.

For selective H₂S removal, the performances (i.e. feed ratio and selectivity) of an aqueous solution of a compound (I) whose amine function is severely hindered are compared with those of a MethylDiethanolAmine that constitutes the reference solvent in a selective deacidizing application for natural gas treatment, and with those of a t-butylaminoethanol solution, a severely hindered secondary monoamine also recommended for such an application (U.S. Pat. No. 4,405,581).

### Example 1

### Operating Procedure for the Synthesis of Amines of General Formula (I)

For information, the following examples illustrate the synthesis of some molecules of the invention, it being understood that all the synthesis possibilities for these molecules, regarding the synthesis paths considered as well as the possible operating modes, are not described here.

### [N,N′-dimethyl-N′-tertiobutyl]-1,2-propanediamine

57.7 g (0.79 moles) tertiobutylamine, 80 ml ethanol and 25.0 g (0.158 moles) 1-dimethylamino-2-chloropropane in chlorhydrate form are fed into an autoclave reactor. The medium is brought to a temperature of 110° C. for 5 hours, then, after returning to ambient temperature, the medium is neutralized with 13.3 g soda pellets for 1 hour at 80° C. After filtering, the medium is distilled. After removing the excess amine and the solvent, 216.8 g of a fraction distilling between 170° C. and 174° C. at atmospheric pressure, whose NMR spectrum is in accordance with the desired theoretical structure, are recovered.

### [N,N′-dimethyl-N′-(3-methoxypropyl)]-1,2-propanediamine

164.9 g (1.85 mole) 3-methoxypropylamine and 59 g (0.37 mole) 1-dimethylamino-2-chloropropane in chlorhydrate form are fed into a drum. The medium is brought to a temperature of 118° C. for 5 hours. After evaporation of the excess amine, at ambient temperature, the medium is neutralized with a solution of 32.4 g soda in 130 ml water. Evaporation of the water under reduced pressure, then filtration of the precipitated salt is carried out. The solid is washed with ether, then the ethereal fraction is added to the product and distillation of the medium is performed. 37.6 g of a fraction distilling between 36° C. and 38° C. in 0.5 mm Hg, whose NMR spectrum is in accordance with the desired theoretical structure, are recovered.

This molecule can also be prepared by condensation of 1 mole of 3-methoxypropylamine with 1.5 mole of dimethylaminoacetone at a temperature slightly above 100° C. allowing continuous removal of the condensation water by means of a Dean-Stark separator. Then, after evaporation of the excess dimethylaminoacetone and drying of the medium, hydrogenation of the imine obtained is conducted at ambient temperature with a stoichiometric amount of sodium tetrahydroborate. This operation leads to the desired molecule.

### Example 2

### Capture Capacity of Amines of General Formula (I) Whose Two Nitrogen Atoms are Separated by Two or Three Carbon Atoms

An absorption test is carried out on aqueous amine solutions in a perfectly stirred closed reactor whose temperature is controlled by a regulation system. For each solution, absorption is conducted in a 50-cm³ liquid volume by injections of pure CO₂ from a reserve. The absorbent solution is first evacuated prior to any CO₂ injection. The pressure of the gas phase in the reactor is then monitored as a function of time after the CO₂ injections. A global material balance on the gas phase allows measurement of the solvent feed ratio α=nb moles of acid gas/nb moles of amine, as a function of the acid gas partial pressure.

By way of example, the feed ratios (α=nb moles of acid gas/nb moles of amine) obtained at 40° C. for different CO₂ partial pressures can be compared between [N,N-dimethyl-N′-tertiobutyl]-1,2-propanediamine and N,N-dimethyl-N′-(3-methoxypropyl)]-1,2-propanediamine absorbent solutions according to the invention and a 30 wt. % MonoEthanolAmine absorbent solution for a post-combustion CO₂ capture application, and a 40 wt. % MethylDiethanolAmine absorbent solution for a natural gas decarbonation application for meeting the liquefied natural gas specifications.

Switching from a quantity for the feed ratio obtained in the laboratory to a quantity characteristic of the method requires some calculations that are explained below for the two applications that are sought.

In the case of a post-combustion CO₂ capture application, the CO₂ partial pressures in the effluent to be treated are typically 0.1 bar with a temperature of 40° C., and a 90% acid gas abatement is sought. The cyclic capacity Δα_{PC} expressed in moles of CO₂ per kg of solvent is calculated, considering that the absorbent solution reaches its maximum thermodynamic capacity at the absorption column bottom α_{PPCO2=0.1bar} and must at least be regenerated below its thermodynamic capacity under the conditions at the top of the column α_{PPCO2=0.01bar} in order to achieve the 90% CO₂ abatement.

Δα_{PC}=(α_{PPCO2=0.1bar}−α_{PPCO2=0,0.1bar})·[A]·10/M

where [A] is the amine concentration expressed in wt. % and M the molar mass of the amine in g/mol.

The reaction enthalpy can be obtained by calculation from several CO₂ absorption isotherms by applying van't Hoff's law.

In the case of a natural gas decarbonation application for an application during obtaining a liquefied natural gas (LNG), the CO₂ partial pressures in the gas to be treated are, for example, 0.3 bar and 1 bar with a temperature of 40° C. A 50 ppm specification is desired here, which at first approximation corresponds to a completely regenerated solvent (α₅₀ₚₚₘ˜0). As above, the cyclic capacity Δα_{LNG} expressed in moles of CO₂ per kg of solvent is calculated, considering that the solvent reaches its maximum thermodynamic capacity at the absorption column bottom α_{PPCO2=0.3bar} and α_{PPCO2=1bar} for partial pressures of 0.3 and 1 bar respectively.

$$Δ {α}_{LNG}^{0 , 3 bar} = ( {α}_{PPCO 2 = 0 , 3 bar} - {α}_{50 ppm} ) \cdot [ A ] \cdot 10 / M \approx ( {α}_{PPCO 2 = 0 , 3 bar} ) \cdot [ A ] \cdot 10 / M$$

$$Δ {α}_{LNG}^{1 bar} = ( {α}_{PPCO 2 = 1 bar} - {α}_{50 ppm} ) \cdot [ A ] \cdot 10 / M \approx ( {α}_{PPCO 2 = 1 bar} ) \cdot [ A ] \cdot 10 / M$$

where [A] is the amine concentration expressed in wt. % and M the molar mass of the amine in g/mol.

Case relative to post-combustion CO₂ capture

| | | | | | | □□ (mol | □H |
|---|---|---|---|---|---|---|---|
| | | T | | PPCO₂ = | PPCO₂ = | CO₂/kg | (kJ/mol |
| Generic name | Concentration | (° C.) | | 0.01 bar | 0.1 bar | Solvent) | CO₂) |
| [N,N-dimethyl-N′- | 30 wt. % | 40 | Feed ratio = | 0.36 | 0.88 | 0.97 | 64 |
| tertiobutyl]-1,2- | | | nCO2/namine | | | | |
| propanediamine | | | | | | | |
| MonoEthanolAmine | 30 wt. % | 40 | | 0.44 | 0.52 | 0.38 | 92 |

Case relative to natural gas decarbonation for a LNG specification

| | | | | | □□^{0.3 bar} | | □□^{1 bar} |
|---|---|---|---|---|---|---|---|
| | | | | PPCO₂ = | (mol | | (mol |
| | | T | | 0.3 | CO₂/kg | PPCO₂ = 1 | CO₂/kg |
| Generic name | Concentration | (° C.) | | bar | Solvent) | bar | Solvent) |
| [N,N-dimethyl-N′- | 30 wt. % | 40 | Feed ratio = | 1.14 | 2.16 | 1.45 | 2.74 |
| tertiobutyl]-1,2- | | | nCO2/namine | | | | |
| propanediamine | | | | | | | |
| MethylDiEthanolAmine | 40 wt. % | 40 | | 0.50 | 1.68 | 0.70 | 2.35 |

This example shows the higher feed ratios that can be obtained by means of an absorbent solution according to the invention, comprising 30 wt. % molecules of general formula (I), at low as well as high acid gas partial pressures.

Furthermore, for a post-combustion fumes capture application where the CO₂ partial pressure in the effluent to be treated is 0.1 bar, this example illustrates the higher cyclic capacity in moles CO₂ per kg of solvent obtained using an absorbent solution according to the invention, comprising 30 wt. % molecules of general formula (I) so as to reach a 90% abatement ratio at the absorber outlet. In this application, where the energy associated with the solvent regeneration is critical, it can be noted that the amines of general formula (I) allowing obtaining a much better compromise than MEA in terms of cyclic capacity and reaction enthalpy.

Furthermore, for a natural gas decarbonation application where the CO₂ partial pressure in the effluent to be treated ranges between 0.3 and 1 bar, this example illustrates the higher cyclic capacity in moles CO₂ per kg of absorbent solution obtained using an absorbent solution according to the invention, comprising wt. % molecules of general formula (I) allowing to reach a 50 ppm CO₂ specification in the gas treated.

### Example 3

### Capacity and Selectivity of H₂S Removal from a Gaseous Effluent Containing H₂S and CO₂ by an Amine Solution of Formula (I) Whose Secondary Amine Function is Severely Hindered

An absorption test is carried out at 40° C. on aqueous amine solutions in a perfectly stirred reactor open on the gas side.

For each solution, absorption is conducted in a 50-cm³ liquid volume by bubbling of a gas stream consisting of a mixture of nitrogen:carbon dioxide:hydrogen sulfide in a volume proportion of 89:10:1, at a flow rate of 30 NL/h for 90 minutes.

The H₂S feed ratio obtained (α=nb moles of H₂S/kg solvent) and the CO₂ absorption selectivity are measured at the end of the test.

This selectivity S is defined as follows:

$$S = ( {α}_{H 2 S} / {α}_{CO 2} ) \cdot \frac{( {CO}_{2} concentration of the gaseous mixture )}{( {H}_{2} S concentration of the gaseous mixture )}$$

that is, under the conditions of the test described here, S=10(α_{H2S}/α_{CO2}).

By way of example, it is possible to compare the feed ratios and the selectivity between a (N-morpholinoethyl)tertiobutylamine absorbent solution according to the invention and a methyldiethanolamine absorbent solution, as well as a 40 wt. % tertiobutylaminoethanol absorbent solution (U.S. Pat. No. 4,405,581).

| | | | H₂S feed | |
|---|---|---|---|---|
| | Concen- | T | ratio | Selec- |
| Compound | tration | (° C.) | (mole/kg) | tivity |
| MDEA | 40% | 40 | 0.15 | 6 |
| t-butylaminoethanol | 40% | 40 | 0.36 | 7.6 |
| (N- | 40% | 40 | 0.29 | 19.2 |
| morpholinoethyl)tertiobutylamine | | | | |

This example illustrates the feed ratio and selectivity gains that can be reached with an absorbent solution according to the invention, comprising 40 wt. % molecules of general formula (I) with severe hindrance of the secondary amine function.

1-14. (canceled)

15. A method of removing acid compounds contained in a gaseous effluent, wherein an acid compound absorption stage is carried out by contacting the effluent with an absorbent solution comprising:
a—water,
b—between 21 and 80 wt. % of a diamine comprising a tertiary amine function and a primary or secondary amine function, the diamine having the general formula (I) as follows: 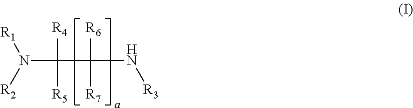
wherein:
a is an integer ranging between 1 and 11;
each radical R1 and R2 is selected independently from an alkyl C1-C12 group or from an alkoxyalkyl C1-C12 group;
each radical R3, R4, R5, R6 and R7 is selected from a hydrogen atom, an alkyl C1-C12 group and an alkoxyalkyl C1-C12 group; and
radical R3 is different from radical R1 and radical R2.

16. A method as claimed in claim 15, wherein R1 and R2 are connected to each other to form a heterocycle of piperidine, pyrrolidine, homopiperidine or morpholine type with a ring of 5 to 8 atoms.

17. A method as claimed in claim 15, wherein the diamine is selected from the group consisting of (N-morpholinoethyl) isopropylamine, (N-piperidinoethyl) isopropylamine, [N,N-dimethyl-N′-(3-methoxypropyl)]-1,2-propanediamine, [N,N-dimethyl-N′-(methane-2-tetrahydro-furfuryl)]-1,2-propane-diamine, [N,N-dimethyl-N′-(2-butyl)]-1,3-propanediamine, [N,N-dimethyl-N′-(2-butyl)]-1,3-propanediamine, [N,N-dimethyl-N′-butyl]-1,3-propanediamine, [N,N-dimethyl-N′-(methyl-2-propyl)]-1,3-propanediamine, [N,N-dimethyl]-1,6-hexane-diamine, [N,N-diethyl]-1,6-hexanediamine and N,-diethyl-1,4-pentanediamine.

18. A method as claimed in claim 16, wherein the diamine is selected from the group consisting of (N-morpholinoethyl) isopropylamine, (N-piperidinoethyl) isopropylamine, [N,N-dimethyl-N′-(3-methoxypropyl)]-1,2-propanediamine, [N,N-dimethyl-N′-(methane-2-tetrahydro-furfuryl)]-1,2-propane-diamine, [N,N-dimethyl-N′-(2-butyl)]-1,3-propanediamine, [N,N-dimethyl-N′-(2-butyl)]-1,3-propanediamine, [N,N-dimethyl-N′-butyl]-1,3-propanediamine, [N,N-dimethyl-N′-(methyl-2-propyl)]-1,3-propanediamine, [N,N-dimethyl]-1,6-hexane-diamine, [N,N-diethyl]-1,6-hexanediamine and N,-diethyl-1,4-pentanediamine.

19. A method as claimed in claim 15, wherein the primary or secondary amine function is connected to at least one quaternary carbon or two tertiary carbons.

20. A method as claimed in claim 16, wherein the primary or secondary amine function is connected to at least one quaternary carbon or two tertiary carbons.

21. A method as claimed in claim 19, wherein the diamine is selected from the group consisting of (N-morpholinoethyl) tertiobutylamine, [N,N-dimethyl-N′-isopropyl]-1,2-propanediamine, [N,N-dimethyl-N′-tertiobutyl]-1,2-propanediamine, [N,N-dimethyl-N′-tertiooctyl]-1,2-propanediamine, [N,N-dimethyl-N′-(2-butyl)]-1,2-propane-diamine and [N,N-dimethyl-N′-terbutyl]-1,3-propanediamine.

22. A method as claimed in claim 20, wherein the diamine is selected from the group consisting of (N-morpholinoethyl) tertiobutylamine, [N,N-dimethyl-N′-isopropyl]-1,2-propanediamine, [N,N-dimethyl-N′-tertiobutyl]-1,2-propanediamine, [N,N-dimethyl-N′-tertiooctyl]-1,2-propanediamine, [N,N-dimethyl-N′-(2-butyl)]-1,2-propane-diamine and [N,N-dimethyl-N′-terbutyl]-1,3-propanediamine.

23. A method as claimed in claim 15, wherein the absorbent solution comprises between 25 and 60 wt. % diamine and between 10 and 90 wt. % water.

24. A method as claimed in claim 16, wherein the absorbent solution comprises between 25 and 60 wt. % diamine and between 10 and 90 wt. % water.

25. A method as claimed in claim 17, wherein the absorbent solution comprises between 25 and 60 wt. % diamine and between 10 and 90 wt. % water.

26. A method as claimed in claim 18, wherein the absorbent solution comprises between 25 and 60 wt. % diamine and between 10 and 90 wt. % water.

27. A method as claimed in claim 19, wherein the absorbent solution comprises between 25 and 60 wt. % diamine and between 10 and 90 wt. % water.

28. A method as claimed in claim 20, wherein the absorbent solution comprises between 25 and 60 wt. % diamine and between 10 and 90 wt. % water.

29. A method as claimed in claim 21, wherein the absorbent solution comprises between 25 and 60 wt. % diamine and between 10 and 90 wt. % water.

30. A method as claimed in claim 22, wherein the absorbent solution comprises between 25 and 60 wt. % diamine and between 10 and 90 wt. % water.

31. A method as claimed in claim 15, wherein the absorbent solution also comprises a non-zero proportion, below 20 wt. %, of an activating compound and the compound comprises a primary or secondary amine function.

32. A method as claimed in claim 16, wherein the absorbent solution also comprises a non-zero proportion, below 20 wt. %, of an activating compound and the compound comprises a primary or secondary amine function.

33. A method as claimed in claim 17, wherein the absorbent solution also comprises a non-zero proportion, below 20 wt. %, of an activating compound and the compound comprises a primary or secondary amine function.

34. A method as claimed in claim 19, wherein the absorbent solution also comprises a non-zero proportion, below 20 wt. %, of an activating compound and the compound comprises a primary or secondary amine function.

35. A method as claimed in claim 21, wherein the absorbent solution also comprises a non-zero proportion, below 20 wt. %, of an activating compound and the compound comprises a primary or secondary amine function.

36. A method as claimed in claim 23, wherein the absorbent solution also comprises a non-zero proportion, below 20 wt. %, of an activating compound and the compound comprises a primary or secondary amine function.

37. A method as claimed in claim 31, wherein the activating compound is selected from the group consisting of: MonoEthanolAmine,
N-butylethanolamine
Aminoethylethanolamine,
Diglycolamine,
piperazine,
N-(2-hydroxyethyl)piperazine,
N-(2-aminoethyl)piperazine,
Morpholine,
3-(methylamino)propylamine.

38. A method as claimed in claim 15, wherein the absorbent solution also comprises a physical solvent selected from among methanol and sulfolane.

39. A method as claimed in claim 15, wherein the acid compound absorption stage is carried out at a pressure ranging between 1 and 120 bars, and at a temperature ranging between 20° C. and 100° C.

40. A method as claimed in claim 15, wherein a regeneration of the absorbent solution laden with acid compounds is performed with at least one of heating, expansion or distillation being performed.

41. A method as claimed in claim 40, wherein the regeneration is carried out at a pressure ranging between 1 and 10 bars, and at a temperature ranging between 100° C. and 180° C.

42. A method as claimed in claim 15, wherein the gaseous effluent is selected from among natural gas, syngas, combustion fumes, refinery gas, Claus tail gases, biomass fermentation gases, cement plant gases and incinerator fumes.

43. A gas treating method as claimed in claim 19, wherein:
selective H2S removal is performed from a gaseous effluent containing H2S and CO₂.
